(19) United States
(12) Patent Application Publication
(10) Pub. No.: US 2006/0168401 A1
(43) Pub. Date: Jul. 27, 2006

(54) Method and structure for high-performance linear algebra in the presence of limited outstanding miss slots

(75) Inventors: Siddhartha Chatterjee, Yorktown Heights, NY (US); John A. Gunnels, Brewster, NY (US); Leonardo R. Bachega, West Lafayette, IN (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/041,935

(22) Filed: Jan. 26, 2005

(51) Int. Cl. G06F 12/00; G06F 15/00

(52) U.S. Cl. 711/122; 708/200

(57) ABSTRACT

A method and structure of increasing computational efficiency in a computer that comprises at least one processing unit, a first memory device servicing the at least one processing unit, and at least one other memory device servicing the at least one processing unit. The first memory device has a memory line larger than an increment of data consumed by the at least one processing unit and has a pre-set number of allowable outstanding data misses before the processing unit is stalled. In a data retrieval responding to an allowable outstanding data miss, at least one additional data is included in a line of data retrieved from the at least one other memory device. The additional data comprises data that will prevent the pre-set number of outstanding data misses from being reached, reduce the chance that the pre-set number of outstanding data misses will be reached, or delay the time at which the pre-set number of outstanding data misses is reached.

### CROSS-REFERENCE TO RELATED APPLICATIONS

The following Application is related to the present Application:

U.S. patent application Ser. No. 10/______, filed on ______, to et al., entitled “______”, having IBM Disclosure YOR8-2004-0450 and IBM Docket No.

### U.S. GOVERNMENT RIGHTS IN THE INVENTION

This invention was made with Government support under Contract No. Blue Gene/L B517552 awarded by the Department of Energy. The Government has certain rights in this invention.

### BACKGROUND OF THE INVENTION

1. Field of the Invention

The present invention generally relates to improving efficiency in executing computer calculations. More specifically, in a calculation process that is predictable, data retrieval takes advantage of the allowable cache miss data retrieval process to orchestrate data accesses in a manner that prevents computation stalls caused by exceeding the machine cache miss limit, thereby allowing the computations to continue “in the shadow” of the cache misses.

2. Description of the Related Art

Typically, performance degradation occurs due to stalls resulting from waiting for cache misses to be resolved, in the context of a limited number of allowable outstanding cache misses before stalling. If this limit is exceeded, then the processor is halted until the cache data retrieval mechanism has a chance to retrieve the necessary additional data.

The conventional method to address this problem is that of attempting to arrange for elements to be in cache and target L1 cache-level optimizations. However, a current trend in computer architecture considers that higher performance in computer computation occurs as the cache level optimization is targeted to higher levels, such as L3 cache-level optimization.

Therefore, a need continues to exist to improve performance in computer computation relative to stalls that occur due to exceeding the allowable outstanding cache misses, particularly a method that achieves cache-level optimization at higher levels of cache-level optimization, such as L3 cache.

### SUMMARY OF THE INVENTION

In view of the foregoing, and other, exemplary problems, drawbacks, and disadvantages of the conventional systems, it is an exemplary feature of the present invention to provide a structure (and method) in which data retrieval is orchestrated in a manner so that stalling does not occur due to exceeding the allowable outstanding cache misses.

It is another exemplary feature of the present invention to provide a method in which data is pre-planned to be carried along into L1 cache with data that is retrieved for the outstanding loads allowed before a pipeline stall occurs.

It is another exemplary feature of the present invention to provide a method of preventing cache-miss stalls in a manner that achieves cache-level optimization at a level of cache higher than L1 cache.

It is another exemplary feature of the present invention to demonstrate this method in the environment of subroutines used for linear algebra processing.

Therefore, in a first exemplary aspect, to achieve the above features, described herein is a method of increasing computational efficiency, including, in a computer comprising at least one processing unit, a first memory device servicing the at least one processing unit, and at least one other memory device servicing the at least one processing unit, wherein the first memory device has a memory line larger than an increment of data consumed by the at least one processing unit, the first memory device has a pre-set number of allowable outstanding data misses before the processing unit is stalled, the method including, in a data retrieval responding to an allowable outstanding data miss, including at least one additional data in a line of data retrieved from the at least one other memory device, the additional data comprising data that will at least one of prevent the pre-set number of outstanding data misses from being reached, reduce the chance that the pre-set number of outstanding data misses will be reached, or delay a time at which the pre-set number of outstanding data misses is reached.

In a second exemplary aspect of the present invention, also described herein is a computer, including at least one processing unit, a first memory device servicing the at least one processing unit, and at least one other memory device servicing the at least one processing unit, wherein the method of computational efficiency just described is executed.

In a third exemplary aspect of the present invention, described herein is a system including at least one processing unit, a first memory device servicing the at least one processing unit, the first memory device having a memory line larger than an increment of data consumed by the at least one processing unit, the first memory device having a pre-set number of allowable outstanding data misses before the processing unit is stalled, at least one other memory device servicing the at least one processing unit, and means for retrieving data such that, in a data retrieval responding to an allowable outstanding data miss, including at least one additional data in a line of data retrieved from the at least one other memory device, where the additional data comprises data that will at least one of prevent the pre-set number of outstanding data misses from being reached or reduce the chance that the pre-set number of outstanding data misses will be reached or delay a time at which the pre-set number of outstanding data misses is reached.

In a fourth exemplary aspect of the present invention, described herein is a signal-bearing medium tangibly embodying a program of machine-readable instructions executable by a digital processing apparatus to perform the method of data retrieval just described.

The techniques of the present invention have been demonstrated to observe a predetermined allowable cache-miss limit, use little extra memory, and are highly efficient.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 visually illustrates an exemplary storage layout and load sequence 100 in accordance with the present invention, for the linear algebra DGEMV subroutine (e.g., Y=AX);

FIG. 2 visually illustrates an exemplary repetition pattern 200 to demonstrate how the loading sequence of the present invention prevents the stalls due to exceeding the limited number of allowable outstanding cache misses;

FIG. 3 illustrates an exemplary hardware/information handling system 300 upon which the present invention can be implemented;

FIG. 4 exemplarily illustrates a CPU 311 that includes a floating point unit (FPU) 402; and

FIG. 5 illustrates a signal bearing medium 500 (e.g., storage medium) for storing steps of a program of a method according to the present invention.

### DETAILED DESCRIPTION OF EXEMPLARY EMBODIMENTS OF THE INVENTION

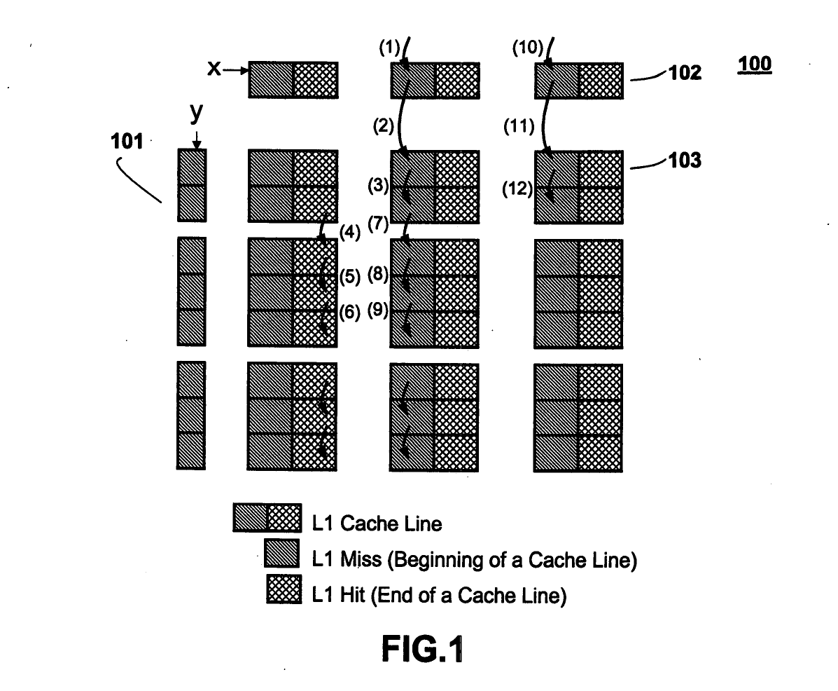

Referring now to the drawings, and more particularly to FIGS. 1-5, an exemplary embodiment of the method and structures according to the present invention will now be described.

The present invention was discovered as part of the development program of the Assignee's Blue Gene/L™ (BG/L) computer in the context of linear algebra processing. However, it is noted that there is no intention to confine the present invention to either the BG/L environment or to the environment of processing linear algebra subroutines.

Before presenting the exemplary details of the present invention, the following general discussion provides a background of linear algebra subroutines and computer architecture, as related to the terminology used herein, for a better understanding of the present invention.

Linear Algebra Subroutines

The explanation of the present invention includes reference to the computing standard called LAPACK (Linear Algebra PACKage). Information on LAPACK is readily available on the Internet.

For purpose of discussion only, Level 2 and Level 3 BLAS (Basic Linear Algebra Subprograms) are mentioned, but it is intended to be understood that the concepts discussed herein are easily extended to other linear algebra mathematical standards and math library modules and, indeed, is not even confined to the linear processing environment. It is noted that the terminology “Level 2” and “Level 3” refers to the looping structure of the algorithms.

That is, Level 1 BLAS routines use only vector operands and have complexity O(N), where N is the length of the vector and, hence, the amount of data involved is O(N). Level 2 BLAS routines are Matrix-vector functions and involve O(Nˆ2) computations on O(Nˆ2) data. Level-3 BLAS routines involve multiple matrices and involve O(Nˆ3) computations on O(Nˆ2) data.

When LAPACK is executed, the Basic Linear Algebra Subprograms (BLAS), unique for each computer architecture and usually provided by the computer vendor (such routines are only really useful on modern architectures if they are targeted for the architecture on which they are being executed, but they need not be supplied by the vendor of the architecture), are invoked. LAPACK comprises a number of factorization algorithms for linear algebra processing (as well as other routines).

For example, Dense Linear Algebra Factorization Algorithms (DLAFAs) include matrix multiply subroutine calls, such as Double-precision Generalized Matrix Multiply (DGEMM). At the core of Level 3 Basic Linear Algebra Subprograms (BLAS) are “L1 kernel” routines, which are constructed to operate at near the peak rate of the machine when all data operands are streamed through or reside in the L1 cache.

The most heavily used type of Level 3 L1 DGEMM kernel is Double-precision A Transpose multiplied by B (DATB), that is, C=C−A^{T}*B, where A, B, and C are generic matrices or submatrices, and the symbology A^{T} means the transpose of matrix A.

The DATB kernel operates so as to keep the A operand matrix or submatrix resident in the L1 cache. Since A is transposed in this kernel, its dimensions are K1 by M1, where K1×M1 is roughly equal to the size of the L1. Matrix A can be viewed as being stored by row, since in Fortran, a non-transposed matrix is stored in column-major order and a transposed matrix is equivalent to a matrix stored in row-major order. Because of asymmetry (C is both read and written), K1 is usually made to be greater than M1, as this choice leads to superior performance.

As pointed out above, the problem addressed by the present invention is that data that is missing in the L1 cache causes cache misses to occur, and processing will stall if a predetermined number of cache misses are outstanding.

The DGEMV [Double-precision General Matrix Vector multiplication] subroutine is used as an example upon which to demonstrate the present invention, but the techniques are applicable for any highly predictive calculation processing (DGEMV is an example that is data bound and DGEMM is an example that is conventionally thought of as compute bound, though, in this case it is both bandwidth and compute bound). The DGEMV subroutine calculates Y=AX, where X and Y are vectors and A is a matrix or a transposed matrix.

FIG. 1 shows an exemplary representative layout 100 of the storage components for this processing, along with the sequence of data retrieval appropriate for the DGEMV example. Register 101 is the accumulator for vector Y. The cache layout 102, 103 for vector X and submatrix A is shown on the right.

The present invention can be described in terms of the relatively simple concept of orchestrating data accesses so as to avoid the stall that results upon exceeding the allowed limit. The numerals 1-12 in FIG. 1 show an exemplary loading sequence for this data orchestrating in the DGEMV processing, as will be discussed in more detail below.

In the context of level-2 BLAS, this data orchestration involves ensuring that the access patterns of the computational routines must conform to the restriction imposed by the limited outstanding load/store queue.

In the context of level-3 BLAS routines and taking DGEMM as an example, this entails two things. First, the data is re-formatted so that it conforms to the access patterns discussed herein. Second, the access patterns of the computational routines must conform to the restriction imposed by the limited outstanding load/store queue.

There are three facts and corresponding implications that are utilized in this invention:

1) A read miss brings a full (L1) cache-line size of data into the L1 cache. This implies:

a) Subsequent reads of this cache line (while in the appropriate time window, after being fetched and before being flushed) will result in L1 hits; and

b) After the initial miss, the data is not only in L1, but in the register into which the fetch was directed.

2) The read miss queue limit is limited (very small) in capacity. This implies:

a) Each read miss should be set to hit a new cache line (if they are not, I a indicates that a slot is being wasted).

3) The core can continue to fetch, decode, and execute floating-point instructions while misses are serviced. The core can also continue to fetch, decode, and execute memory instructions (accesses) while misses are being serviced provided that these memory instructions hit in L1. These two facts imply:

a) The algorithm (code) must find/use enough data (i.e., a software pipeline) to do in the “shadow” of the misses and be ready to issue a read miss as soon as a slot opens up. This is the case of bandwidth-limited routines (i.e. level-1 and level-2 BLAS).

b) The algorithm (code) must execute enough floating point instructions (e.g., a software pipeline) in the “shadow” of the misses and be ready to issue a read miss as soon as a slot opens up. This is the case of computationally-intensive routines (e.g., level-3 BLAS).

For sake of discussion, it is assumed that there are only three outstanding loads allowed, such as currently built into BG/L.

BLAS2:

This invention takes advantage of the number of outstanding loads allowed by the assignee's recently-developed Blue Gene/L™ architecture to make full utilization of the data bandwidth between the L3 cache and the processor. The outstanding loads are the L1 misses allowed before the stall of the software pipeline. After the data is transferred to the registers and the L1 cache, the load queue for the outstanding loads is emptied and new L1 misses can occur without stalling the software pipeline.

The present invention includes restructuring the code of memory-bounded kernels in order to take advantage of the outstanding loads allowed before the stall of the software pipeline and bringing data from different levels of the memory hierarchy efficiently.

In the case of the BG/L architecture, three outstanding double loads (either parallel or crossed) are allowed at once. Each of them brings to the L1 cache the whole L1 cache line of the requested data and loads three double registers with that data. The number of cycles required to bring data from L3 is the number of cycles to bring that amount of data from L3 to L1 given the 5.3 bytes/cycle bandwidth, plus the L1 latency, which is 4 cycles per load. After N cycles, three new cache lines are brought to L1, and three double registers are filled with half of each of those cache lines (each double load brings ½ of a cache line). It is noted that the loads do not have to be “double”, where “double” means two double-precision numbers, since one can take advantage of the data orchestration of the present invention by loading single double-precision numbers at stride-two, for example.

Consequently, the three double loads every N cycles are a bottleneck of a memory-bounded application, in which there is little reuse of data and the performance is determined by how efficiently the processor is fed by data.

This invention uses the scheme described above to restructure exemplarily the memory-bounded kernels of dense linear algebra. It is shown how such a scheme can be used to redesign a version of the DGEMV, a BLAS level 2 kernel, to be L3-optimal (that works with full efficiency when data is coming out of the L3 cache).

The DGEMV kernel, sketched in code format below, computes the y+=Ax operation for a row major (C-like) matrix. Such a kernel loads some elements of y in the registers, referred to herein as “accumulators”, and streams elements of A and x computing the dot products for each accumulator. The following code shows the conceptual idea of that kernel:

For (i=0;i<m;i+=5)
{

T 1 = y [ i ] ;
T 2 = y [ i + 1 ] ;
T 3 = y [ i + 2 ] ;
T 4 = y [ i + 3 ] ;
T5 = y[i+4];
For (j=0;i<n; j++)
{

T1 += A[i][j] * x[j];
T2 += A[i+1][j] * x[j];
T3 += A[i+2][j] * x[j];
T4 += A[i+3][j] * x[j];
T5 += A[i+4][j] * x[j];

}
y[i] = T1;
y[i+1] = T2;
y[i+2] = T3;
y[i+3] = T4;
y[i+4] = T5;

}

It is assumed that all the elements of the vector x and the matrix A are stored in the L3 cache. The outstanding loads are used to touch the beginning of three cache lines which contain elements of the matrix and the vector and bring to the registers the two elements that are in the beginning of those cache lines. Therefore, after the N cycles required to perform the outstanding loads, the first half of each of these cache lines is going to be loaded into the registers and the second half is going to be available in the L1 cache (and can be brought easily to the registers with 4-cycle latency).

As the floating-point instructions go to an execution queue that is different from the memory queue and the memory instructions that do not cause L1 misses can be launched every cycle, independently of the state of the outstanding load queue, the N cycles required for the L3 loads completion can be used to load the elements that are in the L1 cache (e.g., in the second half of the cache lines brought by the previous outstanding loads) and also to perform the floating-point operations required for DGEMV over the data that are loaded into the registers already.

FIG. 1 shows the pattern of the loads (numerals 1-12) required to perform the DGEMV efficiently when data is brought out of L3. Note that, according to the same figure, the L1 misses (outstanding loads) and L1 hits (non-outstanding loads) are interleaved. As stated above, the N cycles given by the outstanding loads allow the floating-point instructions also to be scheduled.

BLAS3:

Reformatting data is a common technique in level-3 BLAS routines and other patent work discusses generalizations of reformatting that extend beyond row-major column-major. Here, the specific re-formatting technique requires:

1) Accommodation (taking advantage) of hardware pre-fetch streams; and

2) Utilizing the register file efficiently.

It is noted that details of these two re-formatting techniques are discussed in the above-referenced co-pending application, the contents of which are incorporated herein by reference, and not the subject of the present invention.

Here, the reformatting incorporates L1 cache-lines (unusual) and the insertion of “blanks” (“don't care” values) into the data in order to bootstrap the process. Without the insertion of these blanks, the system can only be bootstrapped via low-level calls to invalidate lines in the cache (after loads) or the use of an even more complex data structure, which, like the blanks only affects the first and last block of a “stream” (described below).

Take a matrix multiplication where A is M×K, B is K×N, and C is M×N. Typically, because of the load/store imbalance, at the register level of computation, algorithms are constructed to load some (m×n) part of C into the registers, compute m x K′K×n (part of A′ part of B), add the result to C and store the result away. Here we are motivated to ensure that this algorithm can proceed at a high percentage of the peak rate of the machine.

On BG/L, for example, the system can load one quad word from the L3 cache every three cycles. The register file allows us to compute an (m,n,k): (6,6,1) kernel that could, theoretically, proceed at 100% of the peak rate of the machine.

The problem here, as above, has to do with handling L1 cache misses in such an algorithm. For various reasons related to data copying, it is well known in the high performance computing (HPC, e.g., kernel writer) community that one would like to raise the cache level as high as possible, so this highly efficient L3-based algorithm is quite attractive. Problematically, it could choke due to the limited (e.g., three or four) number of L1 miss slots available on the BG/L. More technically, three separate cache line misses are allowed and a fourth miss may be queued if the request is for an item on one of the three cache lines indicated in the current miss queue.

It is assumed that two sub-arrays, Ax and By, are of dimensions that can fit in the L3 cache, with some room left over. Further, it is assumed that Ax is 6*m1 by K and By is K by 6*n1. Here, the values of m1 and n1 would be determined by a blocking from a higher level of the computation.

The algorithm to compute coupled (6,6,1) outer products can be constructed. It is straightforward, as demonstrated in the above-referenced co-pending application, to utilize a data structure that allows sequential loads of data, three quad loads of A and three quad loads of B per (6, 6, 1) outer product. Here, it is shown how to construct an algorithm and design a data structure that allows the misses on (quad loads of) A proceed 2, 1, 2, 1, 2, . . . while those on B are in the sequence 1, 2, 1, 2, 1 . . . , observing the 3-miss limit.

The algorithm proceeds as follows (demonstrating the simplest bootstrapping scheme for the orchestration):

Load(a, b); (loads 1: 6×3 = 18 cycles)
Load(c, d);
Load(e, f);
Load(1,2);
Load(3,4);
Load(5,6);
1 2 3 4 5 6 (op 1:36 FMAs using SIMOMD FMA instructions = 18 cycles)

| | |
|---|---|
| Compute: | a |
| | b |
| | c |
| | d |
| | e |
| | f |

Load(g, h); (loads 2)
Load(i, j);
Load(k, l);
Load(7,8);
Load(9,10);
Load(11,12);

7 8 9 10 11 12 (ops 2)

Compute:

g
h
i
j
k
l

Load 1 {next);
Loop for remainder of matrices (K - 5); Note that there is a small amount
of differentiation on the last iteration in terms of pointers (loads) in a real
algorithm, here, we assume that m1 and n1 are 1 and ignore that (for
simplicity; it is only a minor alteration in the code).

Ops 1 concurrent with Loads 2 {18 cycles each)
Ops 2 concurrent with Loads 1

end Loop
Ops 1 concurrent with Loads 2
Ops 2
// end algorithm

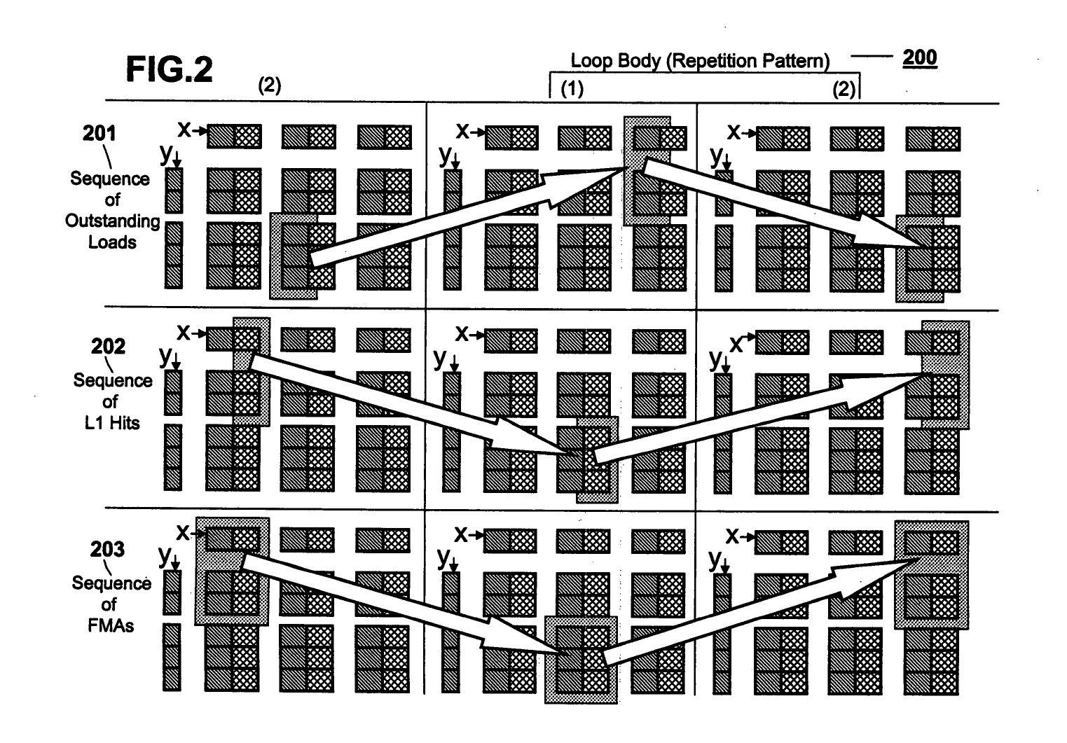

FIG. 2 graphically demonstrates the repetition loop 200 that results from the code above by showing the sequential progress of events in the storage layout 100 shown in FIG. 1. Thus, the upper row 201 shows the sequence of the outstanding loads during which the sequential loading shown in FIG. 1 occurs (e.g., in accordance with the above code section). The middle row 202 shows the sequence of L1 hits, and the lower row 203 shows the sequence of calculations executed in the processing units.

The basic repetition pattern 200, in combination with the loading sequence shown in FIG. 1, provides the data orchestration that prevents the processing stalls caused by exceeding the limit on outstanding cache misses.

The technique embodied in the code above observes the 3-miss limit, the bandwidth available from L3 on the BG/L node, uses little extra memory, and is highly efficient.

Although the present invention was discussed above in view of the 3-miss limit of the BG/L computer processing linear algebra subroutines, it equally applies in a more generic environment (e.g., in which more or fewer “misses” are allowed). More specifically, there are several characteristics of the technique discussed above that allow the present invention to improve processing of the BLAS subroutines.

First, the data processing involved in BLAS subroutines is very predictable, since an iterative and repetitive processing is being executed, using data known to be stored in memory in a predetermined optimal sequence. Thus, one characteristic of the present invention is that the processing be predictable.

Second, the BG/L computer happens to be designed so that one half a cache line is presented to the processor at one time (e.g., as an increment of data to be consumed by the processor). Thus, since an entire cache line is retrieved when cache servicing occurs, it is possible to load down the retrieved cache line with additional information than necessary to service the allowed cache-miss (e.g., additional information that is expected to be used later in a perfectly predictable manner to prevent reaching the limit for the number of outstanding cache misses).

Therefore, a second characteristic is that the machine architecture is such that an entire line of cache not be presented for processing at any one time, thereby providing an extra “empty box” into which can be added “additional data”, such as the data which is known will shortly be data needed to prevent another cache miss.

Preferably, although not required, the cache line will be sized to store an integral multiple of the data fetched for processing (e.g. ½ a cache line is fetched as a unit by the processor). That is, preferably, the cache line comprises an integral number of processing data increments.

Third, as will be understood from the above explanation, the orchestration of the data retrieval would preferably involve a systematic arrangement of hits and misses for data. Thus, for example, as shown in FIG. 1, there is a consistent (and simple) pattern to the cache misses and hits.

Fourth, as also will be readily understood, the data that will be predictably needed should be readily identifiable and, preferably, can be preplanned to be located accordingly in memory for retrieval during cache misses.

Fifth, the present invention preferably operates in an environment in which the data processing can continue during cache miss servicing. For example, in the environment of processing a BLAS discussed above, the machine and the kernel have been designed with a 3-miss limit. That is, the kernel continues to process the data already being processed until it encounters the fourth miss. At that point, the processing will stall.

Therefore, another characteristic of the present invention is that the processing can continue during servicing of misses through the limit of the machine. Many caches today are designed so that processing can continue even though there is a miss in the background.

In the case of the BLAS examples above, the continuation of processing is possible because higher levels of processing are occurring that do not require the new data represented by the limitation for the fourth miss. It should be apparent to one of ordinary skill in the art, after taking the description herein as a whole, that the present invention is not, therefore, limited to a 3-miss limit discussed above.

With these characteristics in mind, it can be said that the present invention teaches the generalized concept of reducing, or even preventing entirely, future cache misses that exceed the cache miss limit by filling future necessary data “under the shadow” of cache accesses. That is, the present invention teaches the concept of reserving space in cache-line retrievals for additional data that is loaded into cache to be available when it will be needed.

It should be noted that, although the discussion above demonstrated the technique for L3cache, the concept is easily extended to any other memory device upon which an L1 cache relies for data streaming in a predictive calculation process.

Indeed, the technique of the present invention could be extended to any processing node having a first memory device that directly services the processing node and a second memory device that also services the processing node by providing a data stream thereto through the first memory device. It is not necessary that the second memory device be co-located with the processing node, since it is conceivable that the second memory device be connected to the processing node via a network bus.

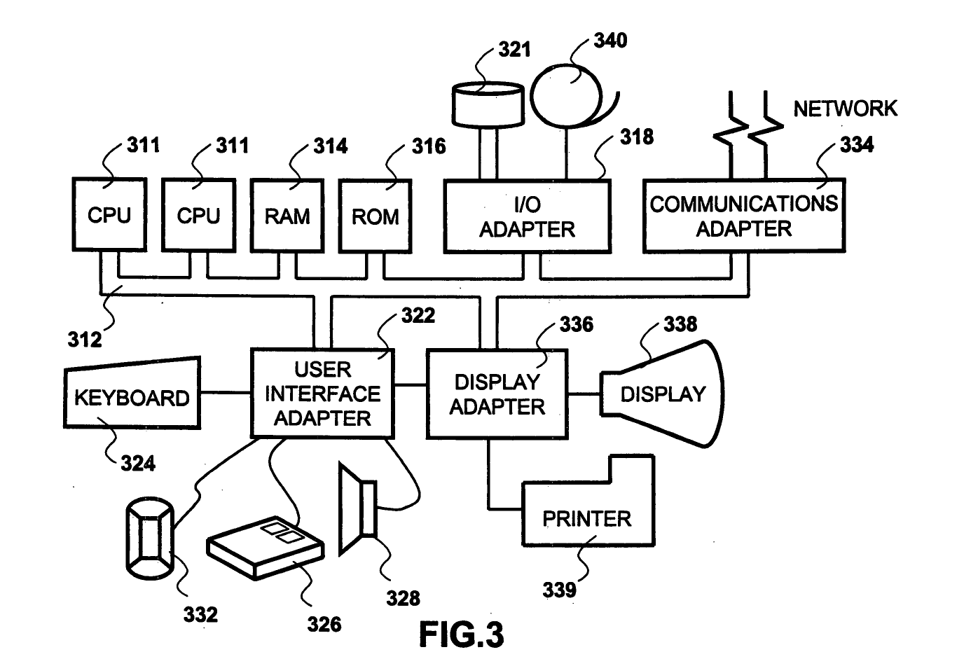

FIG. 3 shows a typical, generic hardware configuration of an information handling/computer system 300 upon which the present invention might be used. Computer system 300 preferably includes at least one processor or central processing unit (CPU) 311. Any number of variations are possible for computer system 300, including various parallel processing architectures and architectures that incorporate one or more FPUs (floating-point units).

In the exemplary architecture of FIG. 3, the CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312 ), user interface adapter 322 (for connecting a keyboard 324, mouse 326, speaker 328, microphone 332, and/or other user interface device to the bus 312), a communication adapter 334 for connecting an information handling system to a data processing network, the Internet, an Intranet, a personal area network (PAN), etc., and a display adapter 336 for connecting the bus 312 to a display device 338 and/or printer 339 (e.g., a digital printer or the like).

Although not specifically shown in FIG. 3, the CPU of the exemplary computer system could typically also include one or more floating-point units (FPUs) and their associated register files that perform floating-point calculations. Hereafter, “FPU” will mean both the units and their register files. Computers equipped with an FPU perform certain types of applications much faster than computers that lack one. For example, graphics applications are much faster with an FPU.

An FPU might be a part of a CPU or might be located on a separate chip. Typical operations are floating point arithmetic, such as fused multiply/add (FMA), which are used as a single entity to perform floating point addition, subtraction, multiplication, division, square roots, etc.

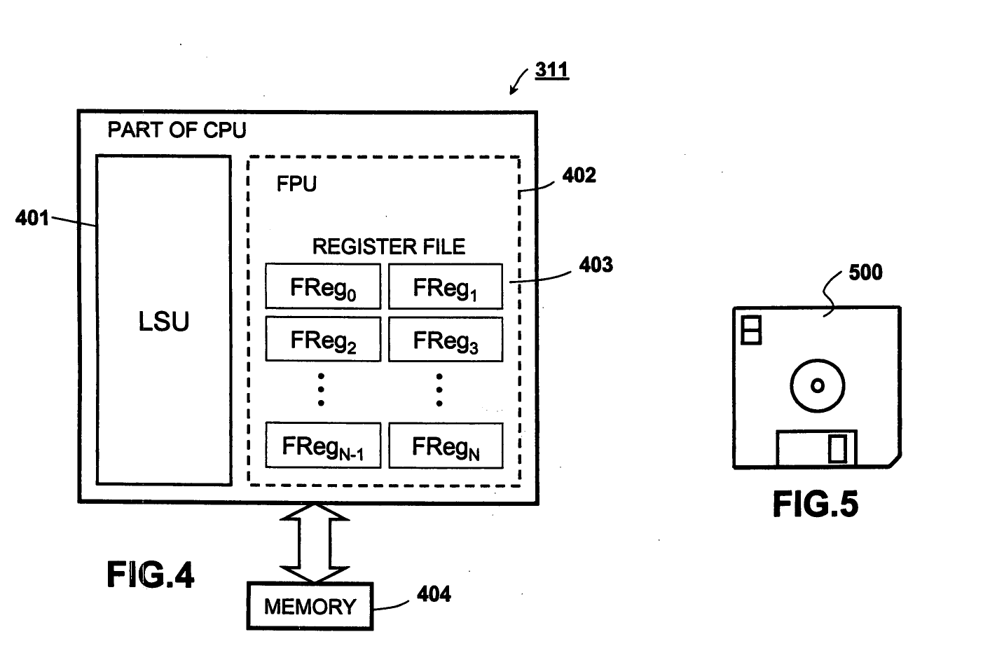

Details of the arithmetic part of the FPU is not so important for an understanding of the present invention, since a number of configurations are well known in the art. FIG. 4 shows an exemplary typical CPU 311 that includes at least one FPU 402. The FPU function of CPU 311 controls the FMAs (floating-point multiply/add), and at least one load/store unit (LSU) 401, which loads/stores data to/from memory device 404 into the floating point registers (FReg's) 403).

In addition to the hardware/software environment described above, a different exemplary aspect of the invention includes a computer-implemented method for performing the invention.

Such a method may be implemented, for example, by operating a computer, as embodied by a digital data processing apparatus, to execute a sequence of machine-readable instructions. These instructions may reside in various types of signal-bearing media.

Thus, this exemplary aspect of the present invention is directed to a programmed product, comprising signal-bearing media tangibly embodying a program of machine-readable instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 500 (FIG. 5), directly or indirectly accessible by the CPU 311.

Whether contained in the diskette 500, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

The second exemplary aspect of the present invention can be embodied in a number of variations, as will be obvious once the present invention is understood. That is, the methods of the present invention could be embodied as a computerized tool stored on diskette 500 that contains a series of matrix subroutines to solve scientific and engineering problems using matrix processing in accordance with the present invention. Alternatively, diskette 500 could contain a series of subroutines that allow an existing tool stored elsewhere (e.g., on a CD-ROM) to be modified to incorporate one or more of the principles of the present invention.

The second exemplary aspect of the present invention additionally raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, the present invention could be implemented by modifying standard matrix processing modules, such as described by LAPACK, so as to be based on the principles of the present invention. Along these lines, each manufacturer could customize their BLAS subroutines in accordance with these principles.

It should also be recognized that other variations are possible, such as versions in which a higher level software module interfaces with existing linear algebra processing modules, such as a BLAS or other LAPACK or ScaLAPACK module, to incorporate the principles of the present invention.

Moreover, the principles and methods of the present invention could be embodied as a computerized tool stored on a memory device, such as independent diskette 500, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules.

It should also be obvious to one of skill in the art that the instructions for the technique described herein can be downloaded through a network interface from a remote storage facility.

All of these various embodiments are intended as included in the present invention, since the present invention should be appropriately viewed as a method to enhance the computation of matrix subroutines, as based upon recognizing how linear algebra processing can be more efficient by using the principles of the present invention.

In yet another exemplary aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all of these various methods of implementing and of using the present invention, including that of the end user who indirectly utilizes the present invention by receiving the results of matrix processing done in accordance with the principles herein.

While the invention has been described in terms of an exemplary embodiment, those skilled in the art will recognize that the invention can be practiced with modification within the spirit and scope of the appended claims.

Thus, for example, it is noted that, although the exemplary embodiment is described in the highly predictable and highly repetitive environment of linear algebra processing, it is not intended as confined to such environments. The concepts of the present invention are applicable in less predictable and less structured environments wherein its incorporation may not actually prevent the pre-set number of outstanding data misses from being reached but would reduce the chance that it is being reached.

Moreover, it is easily recognized that the present invention could be incorporated under conditions in which the additional data being retrieved during normal data retrievals is sufficient only to delay reaching the pre-set number of outstanding data misses.

Further, it is noted that, Applicants' intent is to encompass equivalents of all claim elements, even if amended later during prosecution.

Having thus described our invention, what we claim as new and desire to secure by Letters Patent is as follows:

1. A method of increasing computational efficiency, said method comprising:
in a computer comprising:
at least one processing unit;
a first memory device servicing said at least one processing unit, said first memory device having a memory line larger than an increment of data consumed by said at least one processing unit, said first memory device having a pre-set number of allowable outstanding data misses before said processing unit is stalled; and
at least one other memory device servicing said at least one processing unit,
in a data retrieval responding to an allowable outstanding data miss, including at least one additional data in a line of data retrieved from said at least one other memory device, said additional data comprising data that will at least one of prevent said pre-set number of outstanding data misses from being reached, reduce a chance that said pre-set number of outstanding data misses will be reached, and delay a time at which said pre-set number of outstanding data misses is reached.

2. The method of claim 1, wherein a computation process being executed by said at least one processing unit continues to execute by using data stored in at least one of:
said first memory device; and
at least one register comprising said at least one processing unit.

3. The method of claim 1, wherein data in said at least one other memory device has been pre-arranged so that said at least one additional data is fitted into memory locations for said retrieval.

4. The method of claim 1, wherein said first memory device comprises an L1 cache and said at least one other memory device comprises an L3cache.

5. The method of claim 1, wherein each said memory line of said first memory device comprises an integral number of said increment of data consumed by said at least one processing unit.

6. The method of claim 1, further comprising:
repeating said data retrieval in a repetitive manner so that data hits and data misses of said first memory device are interwoven in a manner that said pre-set number of allowed outstanding data misses is not reached.

7. The method of claim 1, wherein a process being executed by said at least one processing unit comprises a highly predictive calculation process.

8. The method of claim 7, wherein said process comprises a linear algebra subroutine.

9. The method of claim 8, wherein said linear algebra subroutine comprises a Basic Linear Algebra Subprograms (BLAS) L1 kernel routine.

10. The method of claim 6, further comprising:
repeating said data retrieval in a repetitive manner so that data hits and data misses for said first memory device are interwoven in a manner that said pre-set number of outstanding data misses is not reached and such that data is retrieved in an optimal manner from said at least one other memory device.

11. A computer, comprising:
at least one processing unit;
a first memory device servicing said at least one processing unit, said first memory device having a memory line larger than an increment of data consumed by said at least one processing unit, said first memory device having a pre-set number of allowable outstanding data misses before said processing unit is stalled; and
at least one other memory device servicing said at least one processing unit,
wherein, in a data retrieval responding to an allowable outstanding data miss, including at least one additional data in a line of data retrieved from said at least one other memory device, said additional data comprising data that will at least one of prevent said pre-set number of outstanding data misses from being reached, reduce a chance that said pre-set number of outstanding data misses will be reached, and delay a time at which said pre-set number of outstanding data misses is reached.

12. The computer of claim 11, wherein said first memory device comprises an L1 cache and said at least one other memory device comprises an L3cache.

13. The computer of claim 11, wherein said processing unit comprises at least one register, and a computation process being executed by said at least one processing unit continues to execute by using data stored in at least one of:
said first memory device; and
said at least one register comprising said at least one processing unit.

14. The computer of claim 13, wherein said data retrieval repeats in a repetitive manner so that data hits and data misses for said first memory device are interwoven in a manner that said pre-set number of outstanding data misses is not reached and such that data is retrieved in an optimal manner from said at least one other memory device.

15. A system, comprising:
at least one processing unit;
a first memory device servicing said at least one processing unit, said first memory device having a memory line larger than an increment of data consumed by said at least one processing unit, said first memory device having a pre-set number of allowable outstanding data misses before said processing unit is stalled;
at least one other memory device servicing said at least one processing unit; and
means for retrieving data such that, in a data retrieval responding to an allowable outstanding data miss, including at least one additional data in a line of data retrieved from said at least one other memory device, said additional data comprising data that will at least one of prevent said pre-set number of outstanding data misses from being reached, reduce a chance that said pre-set number of outstanding data misses will be reached, and delay a time at which said pre-set number of outstanding data misses is reached.

16. A signal-bearing medium tangibly embodying a program of machine-readable instructions executable by a digital processing apparatus to perform a method of data retrieval, said method comprising:
in a computer comprising:
at least one processing unit;
a first memory device servicing said at least one processing unit, said first memory device having a memory line larger than an increment of data consumed by said at least one processing unit, said first memory device having a pre-set number of allowable outstanding data misses before said processing unit is stalled; and
at least one other memory device servicing said at least one processing unit,
performing a data retrieval responding to an allowable outstanding data miss such that at least one additional data is included in a line of data retrieved from said at least one other memory device, said additional data comprising data that will at least one of prevent said pre-set number of outstanding data misses from being reached, reduce a chance that said pre-set number of outstanding data misses will be reached, and delay a time at which said pre-set number of outstanding data misses is reached.

17. The signal-bearing medium of claim 16, wherein said instructions are encoded on a standalone diskette intended to be selectively inserted into a computer drive module.

18. The signal-bearing medium of claim 16, wherein said instructions are stored in a computer memory.

19. The signal-bearing medium of claim 18, wherein said computer comprises a server on a network, said server at least one of:
making said instruction available to a user via said network; and
executing said instructions on data provided by said user via said network.

20. The signal-bearing medium of claim 16, wherein said method is embedded in a subroutine executing a linear algebra operation.
